(19) United States
(12) Patent Application Publication
(10) Pub. No.: US 2007/0197212 A1
(43) Pub. Date: Aug. 23, 2007

(54) System and method for mobile terminated call blocking

(75) Inventors: Peter J. Marsico, Chapel Hill, NC (US); Travis E. Russell, Clayton, NC (US)

Correspondence Address: HAYNES AND BOONE, LLP, 901 MAIN STREET, SUITE 3100, DALLAS, TX, 75202, US

(73) Assignee: Tekelec, Calabasas, CA (US)

(21) Appl. No.: 11/386,179

(22) Filed: Mar. 22, 2006

Related U.S. Application Data
(60) Provisional application No. 60/753,719, filed on Dec. 23, 2005.

(51) Int. Cl. H04Q 7/20

(52) U.S. Cl. 455/433

(57) ABSTRACT

A system comprises a database operable to mobile terminated call blocking rules, and a mobile terminated call blocking module operable to receive data associated with a mobile terminated call attempt, determine whether the mobile terminated call attempt should be blocked by accessing the database, and block the mobile terminated call attempt in response to determining that the mobile terminated call attempt should be blocked.

### RELATED APPLICATION

This application claims the benefit of U.S. Provisional Patent Application No. 60/753,719 filed Dec. 23, 2005, entitled System and Method for Mobile Terminated Call Blocking.

### BACKGROUND

The ability to selectively block mobile terminated (MT) calls is advantageous for certain situations. The selective prevention of mobile terminated calls would potentially be life-saving for use, for example, by law enforcement or intelligence personnel in situations where there is suspicion that criminals or terrorists may use a mobile communications device to detonate an explosive or other destructive devices.

### SUMMARY

The present disclosure is concerned with systems and methods for selectively preventing the completion of mobile terminated calls in a communications network, such as a global system of mobile communications (GSM) cellular network, an Interim standard 41 (IS-41) cellular network, a WiFi/802.11x, and a WiMAX/802.16 communications network. Selective prevention of mobile terminated (MT) calls is useful, for instance, in situations where there is concern that a criminal or terrorist may use a mobile communications device to detonate an explosive. More specifically, where there is concern that a criminal or terrorist may adapted a mobile communications device to detonate an explosive upon receipt of a call or call attempt by the communication device.

According to one aspect of the present invention, MT calls to subscribers located at or near a tunnel, on an airplane, or near a highly trafficked public area (e.g., sports stadium, public arena, concert hall, airport, shopping area, etc.) are selectively blocked, while still allowing these subscribers to originate phone calls.

According to yet another aspect of the present invention, MT calls to subscribers located at or near a tunnel, on an airplane, or near a highly trafficked public area (e.g., sports stadium, public arena, concert hall, airport, shopping area, etc.) are selectively blocked, except MT calls to authorized subscribers. Where, for example, an authorized subscriber may be a member of an emergency response team (e.g., police, firefighter, military, medical, etc.). Once again, those mobile subscribers that are not able to receive MT calls are still able to originate phone calls.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of exemplary GSM signaling transactions associated with the setup of a typical mobile terminated (MT) call;

FIG. 2 is a block diagram of an embodiment of an integrated mobile terminated call blocking (MTCB) system in a GSM network; and

FIG. 3 is a block diagram of an embodiment of an integrated mobile terminated call blocking (MTCB) system in a GSM network with a tone and announcement server (TAS);

FIG. 4 is a flowchart of an embodiment of a method for household-targeted advertising on the new TV distribution networks;

FIG. 5 is a block diagram of an embodiment of mobile terminated call blocking system that includes a signaling link probe for monitoring additional signaling links in the mobile network;

FIG. 6 is a block diagram of another embodiment of mobile terminated call blocking system that includes a signaling link probe for monitoring additional signaling links in the mobile network;

FIG. 7 is a block diagram of an embodiment of a Short Message Service message blocking system;

FIG. 8 is a block diagram of an embodiment of a standalone MTCB system that is adapted to monitor and selectively intercept signaling messages communicated on a GSM A-interface;

FIG. 9 is a block diagram of an embodiment of a portion of a packet switching system that includes a media gateway controller (MGC) function in combination with a Wi-Fi gateway VLR function; and

FIG. 10 is a block diagarm of an embodiment of a standalone MTCB system adapted to analyze and block MT calls to WiFi subscribers.

### DETAILED DESCRIPTION

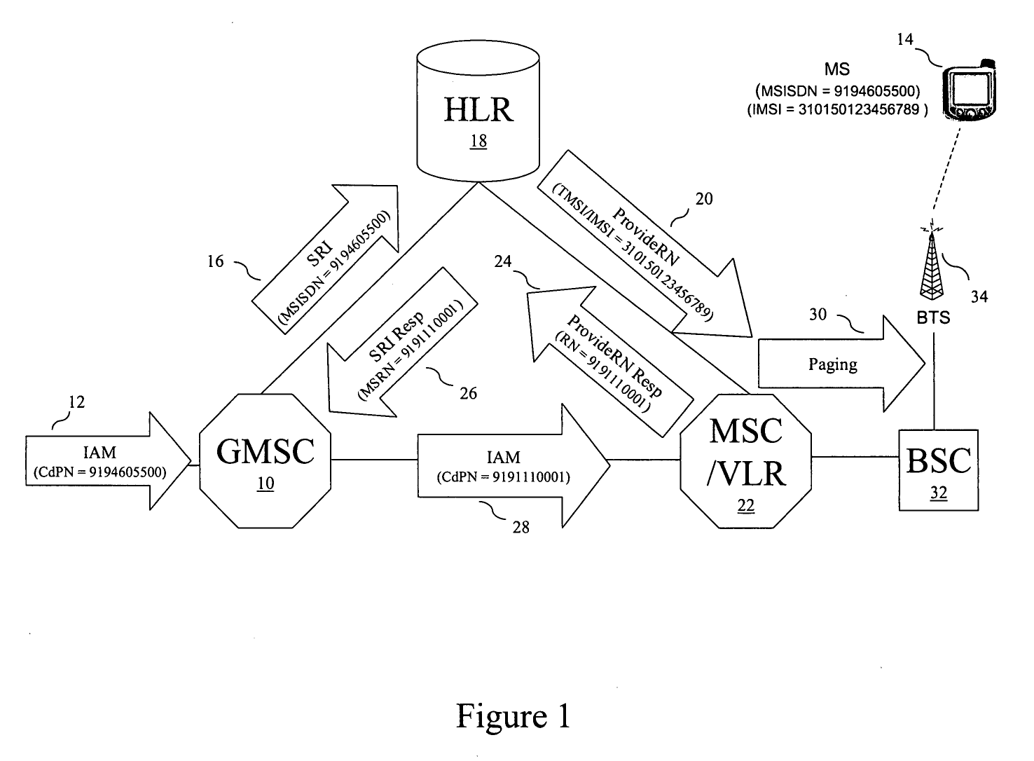

Illustrated in FIG. 1 are exemplary GSM signaling transactions associated with the setup of a typical mobile terminated (MT) call. Call setup related GSM signaling messages/transactions are described in detail in ETSI TS 100 974 v7.6.0 (2000-09) Digital Cellular Telecommunications System (Phase 2+); Mobile Application Part (MAP) Specification (3GPP TS 9.02 version 7.6.0 Release 1998, ETSI EN 300 940 v7.7.1 (2000-10) Digital Cellular Telecommunications System (Phase 2+); Mobile Radio Interface Layer 3Specification (GSM 04.08 version 7.7.1 Release 1998, ETSI 300 590 European digital cellular telecommunications system (Phase 2); Source: SMG 3 Mobile-services Switching Centre-Base Station System (MSC-BSS) interface Layer 3 specification (GSM 08.08), and GSM 09.10 (ETSI 300 605): Digital cellular telecommunication system (Phase 2); Information element mapping between Mobile Station-Base Station System and BSS-Mobile-services Switching Centre (MS-BSS-MSC) Signaling procedures and the Mobile Application Part(MAP), the disclosures of which are incorporated herein by reference in their entirety.

It will be appreciated that although the examples presented herein are based on GSM /signaling system 7 (SS7) network implementations, the present invention is not limited to use in GSM/SS7 networks. Embodiments of the present invention may be deployed in a variety of communication network environments that employ a variety of signaling and communication protocols, such as Internet Engineering Task Force (IETF) SIGTRAN protocols (e.g., M3UA, SUA) and session initiation protocol (SIP).

In FIG. 1, a gateway MSC (GMSC) 10 receives an ISDN user part (ISUP) Initial Address Message (IAM) 12 related to a MT call to a mobile subscriber (MS) 14 associated with the Mobile Station International Integrated Services Digital Network Number (MSISDN) identifier (919) 460-5500. The GMSC 10 generates a mobile application part (MAP) SendRoutingInformation (SRI) message 16 requesting routing information for called MS, and routes the SRI to a home location register (HLR) 18 serving the called MS. The HLR 18 receives the SRI request 16, and subsequently generates a MAP ProvideRoamingNumber (PRN) message 20 requesting a temporary roaming number (RN) for the called MS, and routes the PRN request 20 to the Mobile-Service Switching Centre/Visiting Location Register (MSC/VLR) 22 currently serving the called MS. The MSC/VLR 22 responds to the HLR 18 with a PRN response message 24 which includes the temporary RN that is associated with the called MS. The HLR 18 receives the RN and includes the provided RN in an SRI response message 26, which is returned to the GMSC 10. The GMSC 10 modifies the originally received IAM message to include the temporary RN, and routes the modified IAM message 28 to the MSC/VLR 22 that is currently serving the called MS. The MSC/VLR 22 then generates a PAGING message 30, which is communicated to a base station controller (BSC) 32. BSC 32 then begins the process of establishing a voice path to the called MS 14 over an air interface via a base transceiver station (BTS) 34.

Integrated MSC/VLR Embodiment

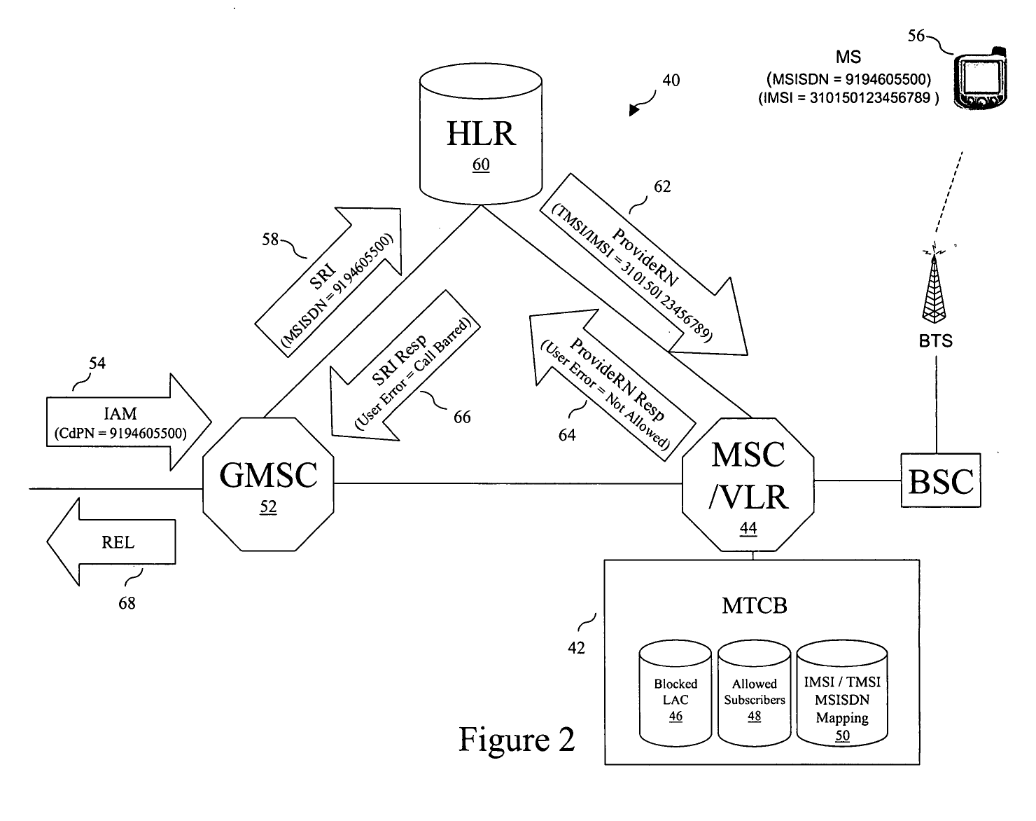

Illustrated in FIG. 2 is an integrated mobile terminated call blocking (MTCB) system 40 for a GSM network. In this embodiment, a MTCB subsystem or function 42 is integrated with and/or collocated with a GSM MSC/VLR 44. The MTCB function 42 is adapted to examine signaling messages that are received by the MSC/VLR 44, and to perform MTCB related processing.

In one embodiment, the MTCB function 42 may include or access a first database 46 that includes a listing of geographic location identifier values, such as location area code (LAC) and/or cell ID (CI) values wherein MT calls are prohibited or blocked. For the purposes of this disclosure, a MT call may include, but is not limited to, a MT voice call, a MT short message delivery, a voice mail waiting notification, a paging service message delivery, and any other wireless communication that may invoke an action (e.g., ringing, alert, alarm, etc.) in a mobile communications terminal that may be used to trigger a malicious event (e.g., detonate an explosive). Blocked LAC/CI rules may also include time/date information, which may be used to specify when a rule is to be enforced. Information may also be included that specifies when a blocked LAC/CI rule expires. Exemplary prohibited LAC/CI rules are presented in Table 1. The first entry in Table 1, for example, defines a prohibited LAC/CI rule, which states that MT calls are prohibited CI 15 associated with LAC 56. The second entry in Table 1 defines a prohibited LAC/CI rule, which states that MT calls are prohibited in all CI associated with LAC 23. The third entry in Table 1 defines a prohibited LAC/CI rule, which states that MT calls are prohibited in all CI associated with LAC 62 from the hours of 9 am to 12 pm, daily. The last entry in Table 1 defines a prohibited LAC/CI rule, which states that MT calls are prohibited in all CI associated with LAC 32 during the period from Dec. 31, 2005 to Jan. 1, 2005.

TABLE 1
Exemplary prohibited LAC/CI rules

| | | Prohibited Time | Prohibited Date |
|---|---|---|---|
| LAC | CI | Range | Range |
| 56 | 15 | * | * |
| 23 | * | * | * |
| 62 | * | 9 am-12 pm | * |
| 32 | * | * | Dec. 31, 2005-Jan. 1, 2005 |

The MTCB function 42 may also include or access a second database 48 that contains a listing of mobile subscribers that are authorized to receive MT calls in prohibited LAC/CI areas. The mobile subscriber identifiers used to identify these allowed mobile subscribers may include, but are not limited to, an IMSI (International Mobile Station Identity), TMSI (Temporary Mobile Subscriber Identity), or MSISDN (Mobile Station International Integrated Services Digital Network Number). LAC/CI areas in which a MS is authorized to receive a MT call may also be specified. Authorized MS rules may include time/date information, which may be used to specify when a rule is to be enforced. Information may also be included that specifies when a rule expires. Exemplary authorized MT subscriber rules are presented in Table 2. The first entry in Table 2, for example, defines a MS MT authorization rule which states that MS identifier (919) 650-2252 is authorized to receive MT calls made to any LAC/CI, regardless of LAC/CI prohibit status defined in Table 1. The second entry in Table 2 defines a MS MT authorization rule, which states that MS identifier (919) 650-2253 is authorized to receive MT calls made to any CI associated with LAC 62. The last entry in Table 2 defines a MS MT authorization rule, which states that MS identifier (919) 650-2253 is authorized to receive MT calls made to CI 85 associated with LAC 32 during the period from Dec. 31, 2005 to Jan. 1, 2005.

TABLE 2
Exemplary authorized MT subscriber rules

| | | | Prohibited | |
|---|---|---|---|---|
| | | | Time | Prohibited Date |
| Subscriber ID | LAC | CI | Range | Range |
| 9196502252 | * | * | * | * |
| 9196502253 | 62 | * | * | * |
| 9196502254 | 32 | 85 | * | Dec. 31, 2005-Jan. 1, 2005 |

The MTCB function 42 may also include or access a third database 50 that contains a mapping of mobile subscriber IMSI/TMSI identifiers to associated MSISDN identifiers and assigned roaming number (RN) identifiers. The MS identifier mapping/correlation information may include date/timestamp information, which may be used to determine the age of a MS identifier mapping entry. Sufficiently old entries may be periodically purged from the database 50. The MTCB function 42 associated with MSC/VLR may be adapted to capture and record MS identifier mapping/correlation information through access of routing information that is maintained by MSC/VLR, and/or through analysis of signaling messages that are received by MSC/VLR. Exemplary signaling messages include, but are not limited to, PRN, SRI and MAP InsertSubscriberData messages. The mobile subscriber identifier mapping information may be used to facilitate the application of authorized MS rules contained in the second database. Exemplary MS identifier mapping/correlation information is presented in Table 3.

TABLE 3
MS identifier mapping/correlation information

| IMSI/TMSI | MSISDN | RN | Timestamp |
|---|---|---|---|
| 310150123456789 | 9194605500 | 9191110001 | 1/1/05, 09:52:21 |
| 310150123456701 | n/a | 9191110002 | 1/1/05, 09:55:21 |
| 310150123456754 | 9194605369 | 9191110003 | 1/1/05, 09:54:21 |

In the example illustrated in FIG. 2, a gateway MSC (GMSC) 52 receives an ISUP IAM 54 related to a MT call to a mobile subscriber (MS) 56 associated with the mobile subscriber ISDN (MSISN) identifier (919) 460-5500. The GMSC 52 generates a MAP SRI message 58 requesting routing information for called MS, and routes the SRI 58 to an HLR 60 serving the called MS 56. The HLR 60 receives the SRI request 58, and generates a MAP ProvideRoamingNumber (PRN) message 62 requesting a temporary roaming number (RN) for the called MS 56, and routes the PRN request 62 to the MSC/VLR 44 currently serving the called MS 56. The MSC/VLR 44 receives the PRN message 62 for a called MS that is identified by an IMSI or TMSI value of 310150123456789. The MSC/VLR 44 uses the IMSI/TMSI value to search internal MSC/VLR databases and determine a LAC and/or CI value associated with the called MS 56. The MSC/VLR 44 then provides the LAC/CI value(s) to the MTCB function 42, which checks the LAC/CI values against prohibited LAC/CI rules specified in the prohibited LAC/CI database 46. If a matching prohibited LAC/CI rule is located, and the rule is “in force”, then the MSC/VLR 44 is adapted to respond to the PRN request 62 with a PRN response message 64 that includes a UserError code indicating the a roaming number could not be provided. An exemplary UserError code value is “Not Allowed”. The PRN response 64 is returned to the serving HLR 60 that originated the PRN request 62, and the serving HLR 60 in turn responds to GMSC 52 with an SRI response message 66 that includes a UserError code indicating that routing information associated with the called MS could not be provided. An exemplary UserError code value is “Call Barred”. The GMSC 52, in turn, may generate an ISUP Release message 68 which effectively terminates the call attempt.

It will be appreciated that by using this approach, the MT call attempt is terminated without paging the called MS handset 56. In other words, the handset or phone of the called MS 56 does not ring, and the called MS is provided no indication that an MT call attempt was blocked. It will also be appreciated that the called MS is still permitted to originate outbound calls, and that only MT calls are blocked.

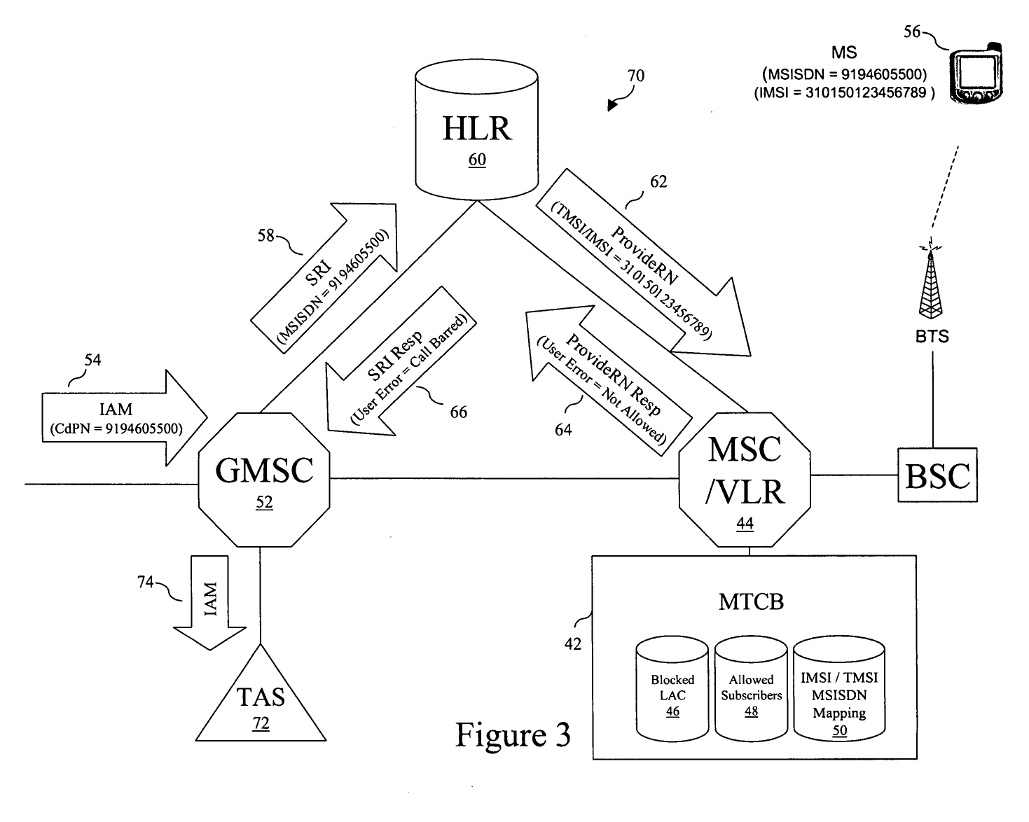

Illustrated in FIG. 3 is a MT call blocking system 70 that involves a tone and announcement server (TAS) 72. In this case, processing proceeds in a manner similar to that described above with respect to FIG. 2, except that upon receiving the SRI response 66 indicating that routing information associated with the called MS 56 could not be provided, the GMSC 52 redirects the call to the TAS 72 via an IAM message 74, which plays an announcement to the calling party, informing the calling party that the call cannot be completed.

With regard to authorized MT subscriber rules database, it will be appreciated that in the examples illustrated in FIGS. 2 and 3, if the TMSI/IMSI/MSISDN associated with the called MS were listed in the authorized MT subscriber rules database, completion of the MT call attempt would have been allowed despite the fact that the called MS was located in a prohibited LAC/CI.

Call Blocking Example Using a Standalone Intrusive MTCB Embodiment

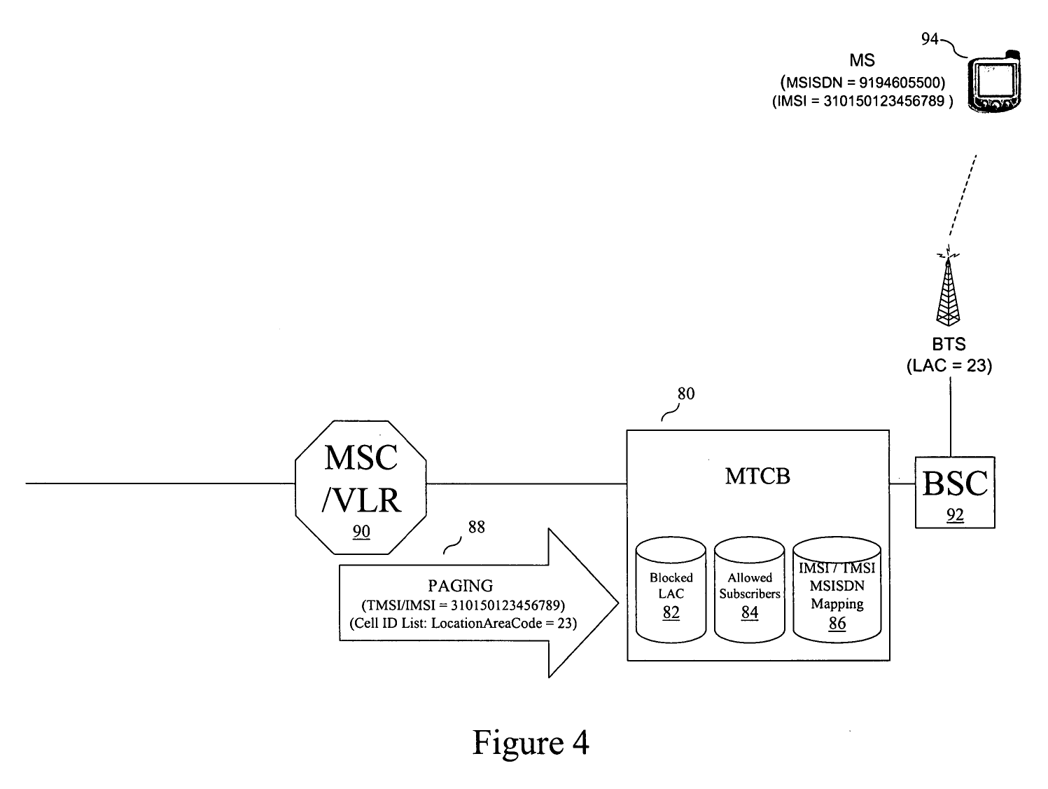

Illustrated in FIG. 4 is an exemplary standalone MTCB function or system 80 that is adapted, in one embodiment, to monitor and selectively intercept signaling messages communicated on a GSM A-interface. Embodiments of the MTCB function 80 may include prohibited LAC/CI, authorized MS, and MS identifier mapping databases 82-86 similar to those described above with respect to the integrated MTCB-MSC/VLR embodiment.

The MTCB function 80 is adapted to monitor and intercept a base station subsystem mobile application part (BSSMAP) PAGING message 88 that is generated and transmitted by a MSC/VLR 90 to the BSC 92. The PAGING message 88 is received and analyzed by the MTCB function 80 to determine which, if any, MTCB rules apply. For example, in the scenario shown in FIG. 4, the intercepted PAGING message 88 is associated with a called MS 94 that is located in LAC 23. The MTCB function 80 accesses the prohibited LAC/CI database 82 (Table 1), and determines that MT calls are prohibited in LAC 23. The MTCB function 80 may additionally extract a mobile subscriber identifier from the PAGING message 88, such as an IMSI or TMSI, and access the MS identifier mapping/correlation database 86 to obtain other identifiers (e.g., MSISDN, RN) associated with the extracted MS identifier. Using at least one of the mobile subscriber identifiers associated with the called MS 94, the authorized MS database 84 is accessed to determine whether the called MS is authorized to receive MT calls in the LAC/CI. In the example illustrated in FIG. 4, the MTCB function 80 determines that the called MS 94 is located in a prohibited LAC/CI, and that the called MS is not authorized to receive MT calls in the prohibited LAC/CI. As a result, the PAGING message 88 is discarded by the MTCB function 80, and therefore not received by the BSC 92. In one embodiment, the MTCB function 80 may not only discard the PAGING message 88, but may also generate a message, which indicates that the paging attempt was unsuccessful.

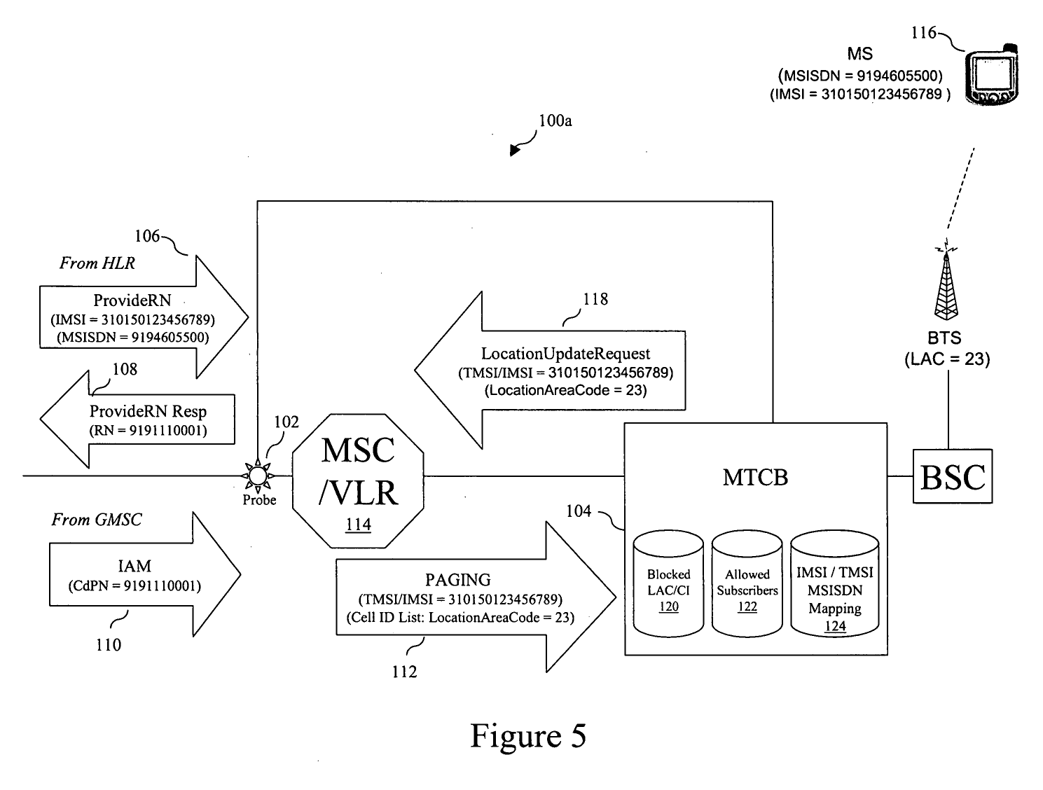

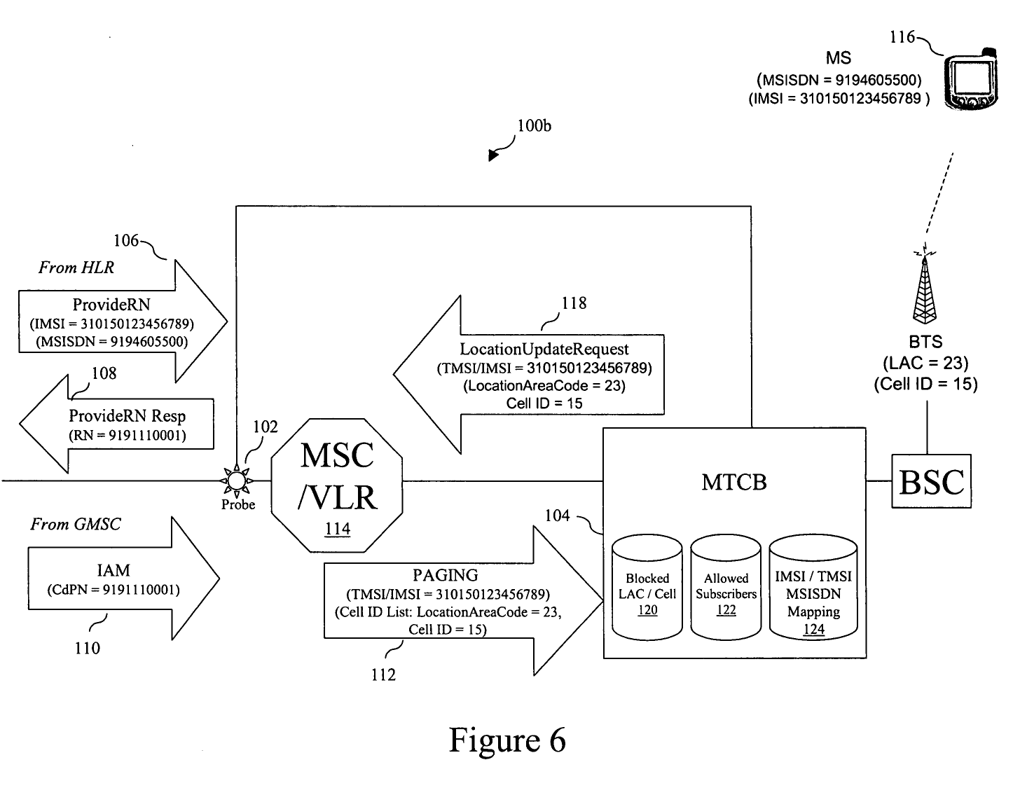

Illustrated in FIGS. 5 and 6 are embodiments of a MT call blocking system 100a and 100b that include a signaling link probe 102 for monitoring additional signaling links in the mobile network. FIG. 5 shows MT call blocking system 100a via a LAC-based blocking scheme, and FIG. 6 shows MT call blocking system 100b via cell ID-based blocking. The monitoring of additional signaling links enables the MTCB function 104 to obtain additional called MS identification information associated with a MT call attempt. For example, by monitoring MAP ProvideRoamingNumber messages 106, PRN Response messages 108, MAP InsertSubscriberData, ISUP IAM 110, PAGING messages 112 or other messages communicated to or from the MSC/VLR 114, the MTCB function 104 may obtain at least a portion of the information necessary to associate an IMSI identifier, a TMSI identifier, a MSISDN identifier, and a Roaming Number identifier related to a called MS 116. The MTCB function 104 may also monitor and extract relevant signaling information from observed BSSMAP LocationUpdateRequest messages 118 sent over the A-interface. Such additional MS identification gathered may be stored in the authorized MS database, as previously described. This additional MS identification information may be useful with respect to MTCB implementations that include “authorized MS” whitelist-type functionality. As described above, the MTCB function 104 is operable to access databases 120-124 for prohibited LAC/CI, allowed subscriber, and IMSI/TMSI/MSISDN mapping data.

It will be appreciated that by using these approaches, the MT call attempt is blocked/terminated even though the MSC/VLR 114 attempted to page the called MS handset 116. In other words, the handset or phone of the called MS 116 does not ring, and the called MS is provided no indication that an MT call attempt was blocked. It will also be appreciated once again that the called MS is still permitted to originate outbound calls, and that only MT calls are blocked.

Mobile Terminated Short Message Service Blocking

ETSI TS 100 942 v7.0.0 (1999-08) Digital Cellular Telecommunications System (Phase 2+); Point to Point (PP) Short Message Service (SMS) Support On Mobile Radio Interface (GSM 04.11 version 7.0.0 Release 1998), the disclosure of which is incorporated herein by reference in its entirety, describes procedures for delivering a MT SMS message in a GSM network. It will be appreciated that the MTCB function may be adapted to selectively block mobile terminated SMS messages to called parties/message recipients that are roaming in a prohibited LAC/CI using techniques and procedures that are similar to the integrated and standalone embodiments described above with respect to MT voice calls.

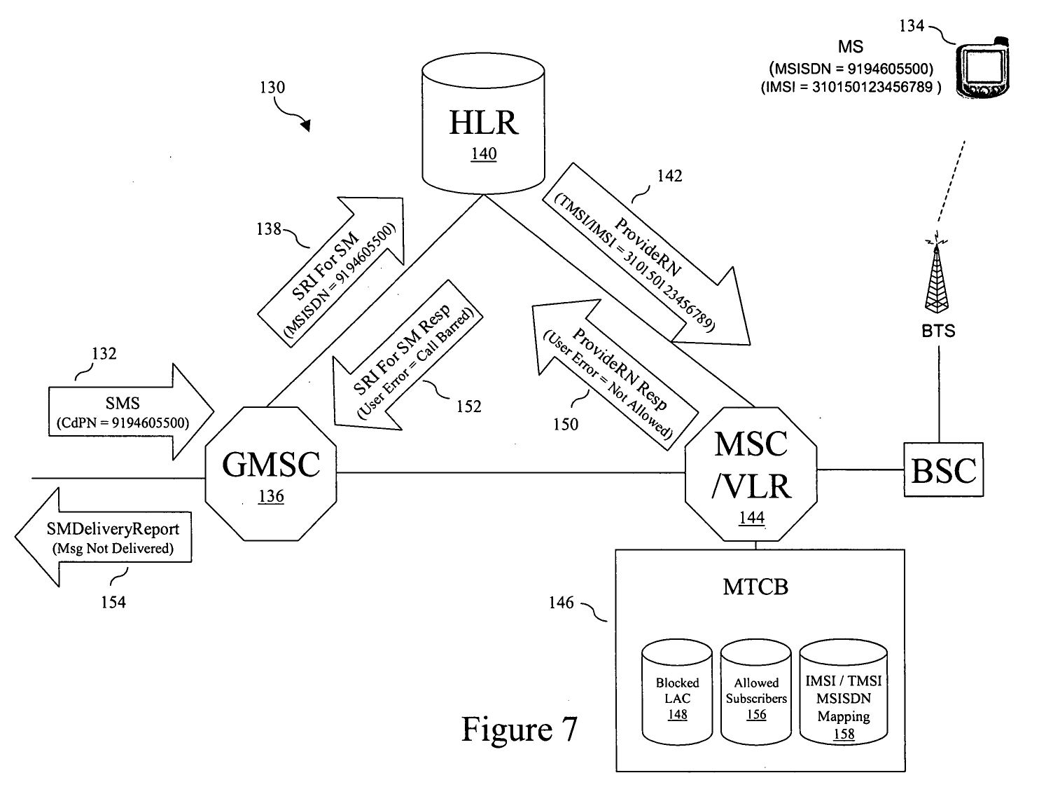

Illustrated in FIG. 7 is a SMS blocking system 130, where an SMS message 132 intended for/addressed to a mobile subscriber 134 with an MS identifier of 9194605500 is received by a GMSC 136. The GMSC 136 generates a MAP SendRoutingInformationForSM (SRI For SM) message 138 requesting routing information for called MS 134, and routes the SRI 138 to a home location register (HLR) 140 serving the recipient MS 134. The serving HLR 140 receives the SRI For SM request 138, and subsequently generates a MAP ProvideRoamingNumber (PRN) message 142 requesting a temporary roaming number (RN) for the SMS message recipient, and routes the PRN request 142 to an MSC/VLR 144 currently serving the recipient MS 134. The MSC/VLR 144 receives the ProvideRoamingNumber request 142 for the recipient MS that is identified by an IMSI or TMSI value of 310150123456789. The MSC/VLR 144 uses the IMSI/TMSI value to search internal MSC/VLR databases and determine a LAC and/or CI value associated with the recipient MS 134. The MSC/VLR 144 provides the LAC/CI value(s) to a MTCB function 146, which checks the LAC/CI values against prohibited LAC/CI rules specified in a prohibited LAC/CI database 148. If a matching prohibited LAC/CI rule is located, and the rule is “in force”, then the MSC/VLR 144 is adapted to respond to the PRN request 142 with a PRN response message 150 that includes a UserError code indicating the a roaming number could not be provided. An exemplary UserError code value is “Not Allowed”. The PRN response 150 is returned to the serving HLR 140 that originated the PRN request 142, and the serving HLR 140 in turn responds to the GMSC 136 with an SRI For SM response message 152 that includes a UserError code indicating that routing information associated with the called MS 134 could not be provided. An exemplary UserError code value is “Call Barred”. The GMSC 136, in turn, may discard the SMS message 132, which effectively terminates the SMS delivery attempt, and may optionally generate a delivery report notification message 154 that notifies the originator of the SMS message that delivery was not successful.

In addition to checking against the data in the LAC/CI database 148, the MTCB 146 may also access data in an allowed subscriber database 156 and an IMSI/TMSI/MSISDN mapping database 158.

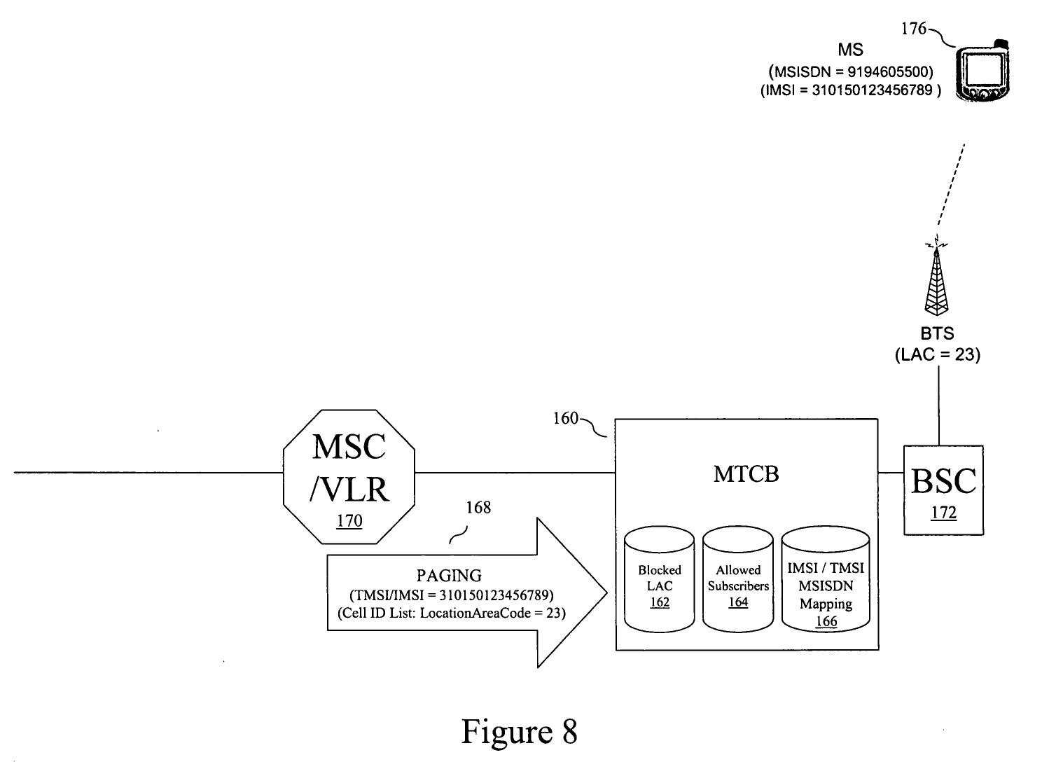

Illustrated in FIG. 8 is an exemplary standalone MTCB function or system 160 that is adapted, in one embodiment, to monitor and selectively intercept signaling messages communicated on a GSM A-interface. Embodiments of the MTCB function 160 may include prohibited LAC/CI, authorized MS, and MS identifier mapping databases 162-166 similar to those described above with respect to the integrated MTCB-MSC/VLR embodiment.

The MTCB function 160 is adapted to monitor and intercept a base station subsystem mobile application part (BSSMAP) PAGING message 168 that is generated and transmitted by a MSC/VLR 170 to a BSC 172 in response to the receipt of a MT Forward SM message 174. The PAGING message 168 is received and analyzed by the MTCB function 160 to determine which, if any, MTCB rules apply. For example, in the scenario shown in FIG. 8, the intercepted PAGING message 168 is associated with a called MS 176 that is located in LAC 23. The MTCB function 170 accesses the prohibited LAC/CI database 162 (Table 1), and determines that MT calls are prohibited in LAC 23. The MTCB function 160 may additionally extract a mobile subscriber identifier from the PAGING message 168, such as an IMSI or TMSI, and access the MS identifier mapping/correlation database 166 to obtain other identifiers (e.g., MSISDN, RN) associated with the extracted MS identifier. Using at least one of the mobile subscriber identifiers associated with the called MS 176, the authorized MS database 164 is accessed to determine whether the called MS is allowed to receive MT SMS messages in the LAC/CI. In the example illustrated in FIG. 8, the MTCB function 160 determines that the recipient MS 176 is located in a prohibited LAC/CI, and that the recipient MS is not authorized to receive MT SMS in the prohibited LAC/CI. As a result, the PAGING message 168 is discarded by the MTCB function 160, and therefore not received by the BSC 172. In one embodiment, the MTCB function 160 may not only discard the PAGING message 168, but may also generate a message, which indicates that the paging attempt was unsuccessful.

It will be appreciated that by using these approaches, the MT SMS delivery attempt is blocked/terminated even though the MSC/VLR 170 attempted to page the handset of the recipient MS. In other words, the handset or phone of the recipient MS 176 does not announce or alert the MS that an SMS message is being/has been delivered, and the recipient MS is provided no indication that an MT SMS delivery attempt was blocked. It will also be appreciated once again that the recipient MS is still permitted to originate SMS messages, and that only MT SMS delivery attempts are blocked.

Blocking WiFi Terminated Calls

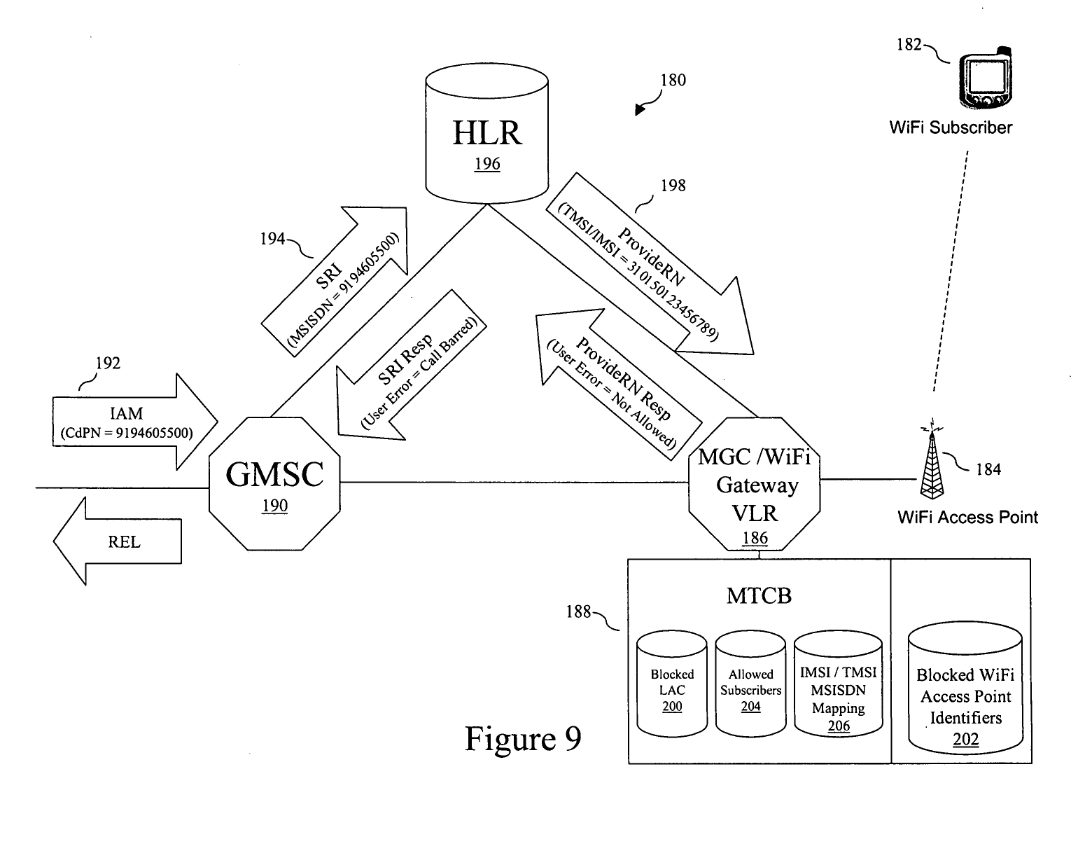

Described in co-pending U.S. patent application Ser. No. ______, Methods, Systems, And Computer Program Products For Providing Wireless-Fidelity (Wi-Fi) Gateway Visitor Location Register (VLR) Functionality, are systems and methods for terminating calls and delivering messaging service messages in a hybrid cellular/WiFi networking environment. Illustrated in FIG. 9 is a hybrid GSM cellular-WiFi networking environment 180. A mobile WiFi subscriber 182 can wirelessly communicate in a Wi-Fi network via one or more Access Points (APs) 184. Each AP 184 can provide service to a geographic region known as a hotspot, and may be assigned a network address such as an Internet protocol (IP) address. Each AP 184 may also include wired communications capabilities, such as Ethernet capabilities. APs can have a wireless transceiver that operates according to various wireless standards, such as wireless Ethernet based on the Institute of Electrical and Electronics Engineers (IEEE) 802.11 standard. The WiFi mobile subscriber handset/communication devices 182 may include, but are not limited to, a computer system, such as a portable computer, a personal digital assistant (PDA), an Internet appliance, a mobile or cellular telephone, or other wired or wireless device. The WiFi communication devices 182 can also include various wireless or wired communication devices, such as a wireless Ethernet card, paging logic, RF communication logic, a wired Ethernet card, a modem, a DSL device, an ISDN device, an ATM device, a parallel or serial port bus interface, or other type of communication device.

Illustrated in FIG. 9 is a portion of a packet switching system, that includes a media gateway controller (MGC) function in combination with a Wi-Fi gateway VLR function, the combination being referenced by number 186. The Wi-Fi gateway VLR function may include a mapping or routing table to provide information on the current IP address of the subscriber, so that a call can be completed to a WiFi mobile subscriber using VoIP.

A Wi-Fi gateway VLR can include a Wi-Fi gateway VLR function for tracking and registering the communication devices roaming in the service area of a Wi-Fi network. More particularly, Wi-Fi gateway VLR function is adapted to track and register those subscribers that have been granted combined Wi-Fi/GSM network access rights. For example, a Wi-Fi gateway VLR function may track and process those subscribers that have been granted Wi-Fi/GSM service. A Wi-Fi gateway VLR function may include a database of provisioned dual network subscribers, such as the data shown in Tables 4 and 5 below. In the example shown in Table 4, dual network Wi-Fi/GSM subscribers are identified by a GSM IMSI value. In the example of Table 5, dual network Wi-Fi/GSM subscribers are identified by either a GSM IMSI value or a Wi-Fi identifier such as an IP address, a MAC address, or other network identifier.

TABLE 4
Dual Network Subscriber List
IMSI
312332121255555
312332121255567
312332121255435

TABLE 5
Dual Network Subscriber List with Wi-Fi ID

| Wi-Fi ID | IMSI |
|---|---|
| 100.100.10.10 | 312332121255555 |
| 100.100.10.11 | 312332121255567 |
| 100.100.10.20 | 312332121255435 |

The Wi-Fi gateway VLR function includes a database for storing information regarding a wireless subscriber to a GSM cellular network. The Wi-Fi gateway VLR function is also adapted to associate a temporary cellular network identifier, such as a GSM mobile subscriber roaming number (MSRN) with a dual network subscriber that has roamed into the service area of the Wi-Fi gateway VLR function.

A Wi-Fi gateway VLR function may maintain a subscriber Wi-Fi/GSM mapping table. Table 6 below shows data in an exemplary subscriber Wi-Fi/GSM mapping table.

TABLE 6
Exemplary Subscriber Wi-Fi/GSM Mapping Information

| | | | Serving | | |
|---|---|---|---|---|---|
| | | Serving | Access | Real IP | Alias IP |
| IMSI | MSRN | MGC ID | Point ID | Address | Address |
| 312332121255555 | 9193452020 | 9191001111 | 100.255.50.50 | 1.234.56.789 | 1.123.45.678 |
| 312332121255567 | 9193452021 | 9191001111 | 100.255.50.51 | 1.345.67.890 | 1.456.78.910 |

While the subscriber is active in the Wi-Fi network and within the service area of Wi-Fi gateway VLR function, the subscriber's Wi-Fi reachability information (e.g., serving Access Point identifier) may be maintained at the Wi-Fi gateway VLR function. Each time that a subscriber roams from one Wi-Fi access point to another Wi-Fi access point, an HLR update is not required. An HLR update is only required if the subscriber roams into a service area controlled by a different Wi-Fi gateway VLR, or if the subscriber leaves the Wi-Fi network (roams out, or de-activates).

In the embodiment shown in FIG. 9, a MTCB function or system 188, similar in form and function to that previously described above, is integrated and/or collocated with the MGC/WiFi Gateway VLR function 186. A gateway MSC (GMSC) 190 receives an ISUP IAM 192 related to the WiFi subscriber 182. The GMSC 190 generates a MAP SRI message 194 requesting routing information for called MS, and routes the SRI 194 to an HLR 196 serving the WiFi subscriber 182. The HLR 196 receives the SRI request 194, and generates a MAP ProvideRoamingNumber (PRN) message 198 requesting a temporary roaming number (RN) for the WiFi subscriber 182, and routes the PRN request 198 to the MGC/WiFi Gateway VLR 186 currently serving the WiFi subscriber 182.

As such, upon receipt of the MAP ProvideRoamingNumber request 198 by the MGC/WiFi Gateway VLR function 186, the MTCB function 188 is adapted to examine call blocking rules, in a manner similar to that previously described, and determine if a MT call to the called WiFi MS is prohibited. In this case, instead of or in addition to maintaining a list of prohibited LAC/CI values in a prohibited LAC/CI database 200, the MTCB 188 is also adapted to store an identifier associated with a prohibited WiFi access point in a database 202. Exemplary WiFi access point identifiers include, but are not limited to, an Internet protocol (IP) address, a UDP/TCP port identifier, a URI, a URL, and a MAC address. Exemplary prohibited cellular-WiFi LAC/CI/AP rules are presented in Table 7.

TABLE 7
Exemplary prohibited LAC/CI/AP rules

| | | | Prohibited Time | Prohibited Date |
|---|---|---|---|---|
| LAC | CI | AP | Range | Range |
| n/a | n/a | 100.10.1.12 | * | * |
| 23 | * | n/a | * | * |
| 62 | * | n/a | 9 am-12 pm | * |
| 32 | * | n/a | * | Dec. 31, 2005-Jan. 1, 2005 |

It will be appreciated that, in the WiFi embodiment, the prohibited AP information is used in a manner that is analogous to LAC/CI use previously described. The MTCB 188 may also consult an authorized MS database 204 that includes a listing of cellular and WiFi mobile subscribers that are authorized to receive MT calls. Exemplary authorized MT cellular and WiFi subscriber rules are presented below in Table 8.

TABLE 8
Exemplary authorized MT cellular/WiFi subscriber rules

| | | | | Prohibited | Prohibited |
|---|---|---|---|---|---|
| | | | | Time | Date |
| Subscriber ID | LAC | CI | AP | Range | Range |
| Bill@Tekelec.com | n/a | n/a | * | * | * |
| 9196502252 | * | * | n/a | * | * |
| 9196502253 | 62 | * | n/a | * | * |
| 9196502254 | 32 | 85 | n/a | * | Dec. 31, 2005-Jan. 1, |
| | | | | | 2005 |

It will be appreciated that, in the WiFi embodiment, cellular and WiFi subscriber identifier mapping/correlation may be acquired, maintained in a database 206 and used in a manner similar to that described above with respect to a pure GSM cellular implementation. WiFi subscriber identifiers may include, but are not limited to, a domain—user name format (e.g., email address format), a Session Initiation Protocol (SIP) URI, or an IP address. Exemplary cellular-WiFi mobile subscriber identifier mapping/correlation data is presented in Table 9.

TABLE 9
Cellular - WiFi MS identifier mapping/correlation information

| IMSI/TMSI | MSISDN | RN | WiFi ID | Timestamp |
|---|---|---|---|---|
| 310150123456789 | 9194605500 | 9191110001 | Ed@aol.com | 1/1/05, 09:52:21 |
| 310150123456701 | — | 9191110002 | 100.1.1.4 | 1/1/05, 09:55:21 |
| 310150123456754 | 9194605369 | 9191110003 | — | 1/1/05, 09:54:21 |

Returning again to the example scenario illustrated in FIG. 9, it will be appreciated that the integrated MTCB function 188 is adapted to cause the MGC/WiFi gateway VLR function 186 to respond to the PRN request 198 with a UserError, in the case where a MT call attempt is made to a prohibited AP. This scenario is similar to the scenario previously presented and discussed with respect to FIG. 2.

Blocking WiFi Terminated Calls With Standalone MTCB

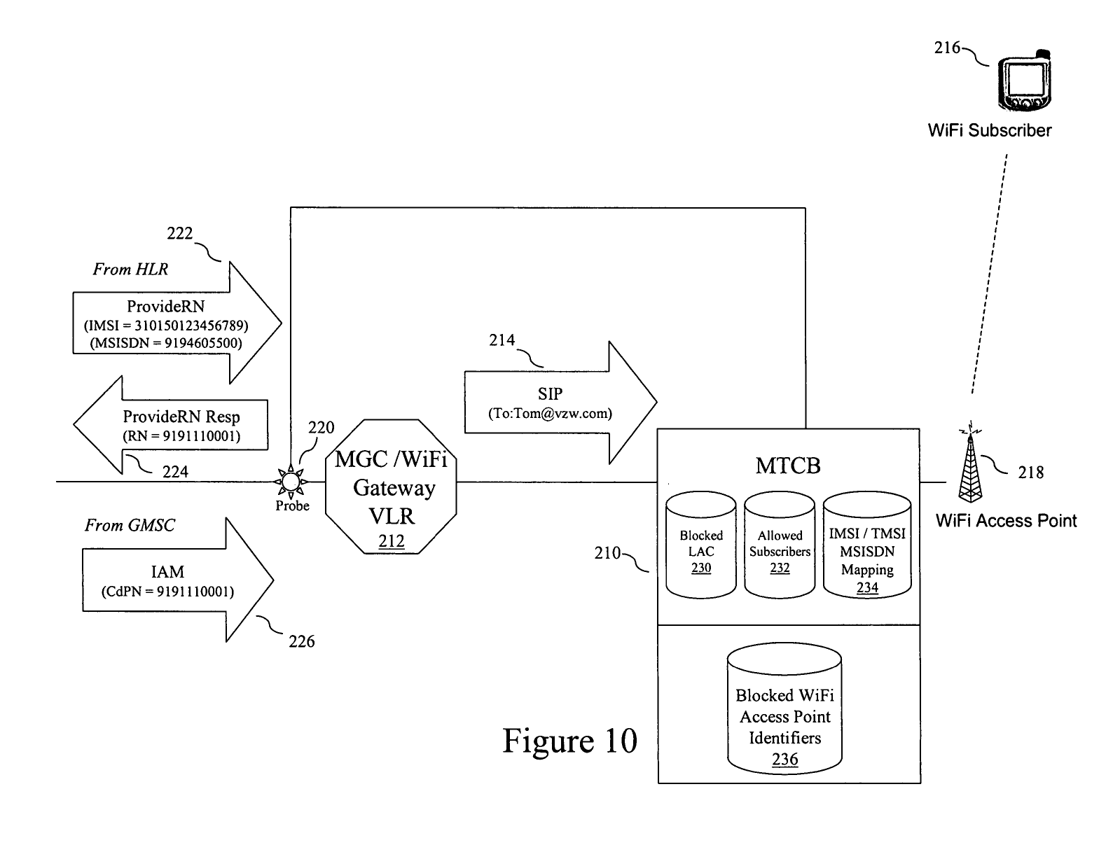

Illustrated in FIG. 10 is an exemplary deployment of a standalone MTCB function or system 210 that is adapted to analyze and block MT calls to WiFi subscribers, if the WiFi subscribers are being served by a prohibited WiFi AP. In this embodiment, a MGC/WiFi gateway VLR function 212 may generate a SIP signaling message 214 associated with the setup of a MT call to a WiFi subscriber 216, where the call is originated from a non-SIP network such as a GSM cellular or PSTN network. Of course, in the case of a WiFi-to-WiFi or SIP-to-WiFi (e.g., IP multimedia subsystem-to-WiFi, etc.), where SIP is the native signaling protocol, then MGC/WiFi gateway VLR function 212 may create a new SIP MT call setup message or simply modify a received SIP MT call setup message and route the SIP message to or towards the WiFi AP 218 serving the called WiFi subscriber.

In this case, the standalone MTCB function 210 is adapted to monitor and intercept the SIP MT call setup message 214 before it reaches the serving WiFi AP 218. A signaling link probe 220 may also be used for monitoring additional signaling links in the network. The monitoring of additional signaling links enables the MTCB function 210 to obtain additional called WiFi subscriber identification information. For example, by monitoring MAP ProvideRoamingNumber messages 222, PRN Response messages 224, ISUP IAM 226, or other messages communicated to or from the MGC/WiFi Gateway VLR 212, the MTCB function 210 may obtain at least a portion of the information necessary to associate an IMSI identifier, a TMSI identifier, a MSISDN identifier, and a Roaming Number identifier related to the WiFi subscriber 216. The MTCB 210 is adapted to perform call blocking processing, similar to that previously described, and determine whether the MT call attempt is associated with a prohibited AP. The MTCB 210 may access a blocked 1 AC database 230, allowed subscriber database 232, IMSI/TMSI/MSISDN mapping database 234, and a blocked WiFi AP identifier database 236. In one embodiment, The MTCB 210 is adapted to examine IP address information associated with the SIP message 214 and determine if the IP address corresponds to the IP address of a prohibited WiFi AP. If the IP address does correspond to the IP address of a prohibited WiFi AP, then the SIP message is discarded, and MT call setup to the called WiFi subscriber is terminated. The MTCB 210 may optionally generate and transmit a SIP message that indicates that the attempted MT call setup was not successful, and may provide addition information to the calling party. Alternatively, in a manner similar to that described previously and illustrated in FIG. 3, the MTCB may facilitate redirection of the call to a TAS or similar announcement server so as to provide the calling party with an indication that the MT call was blocked.

The cellular-WiFi embodiments described herein may also be used to block the delivery of messaging service messages, such as SMS, multimedia messages, and instant messages, in a manner similar to that previously described with respect to SMS delivery blocking in a GSM cellular environment.

It will be appreciated that by using these approaches, the MT call attempt is blocked/terminated even though the MGC/WiFi gateway VLR function attempted route the SIP call setup message to the WiFi subscriber. In other words, the handset or phone of the called WiFi MS does not ring, and the called WiFi MS is provided no indication that a MT call attempt was blocked. It will also be appreciated once again that the called WiFi MS is still permitted to originate outbound calls, and that only MT calls are blocked. It will be appreciated that embodiments of the present disclosure may be deployed in WiFi network environments that do not include a MGC/WiFi gateway VLR function. Accordingly, MT calls to WiFi subscribers residing in a prohibited geographic are may be blocked regardless of the type of network from which the call is originated.

The embodiments shown above may also be adapted for present and future communication protocols or technologies such as WiMAX/802.16 and others.

In short, it will be appreciated that the MT call blocking systems and methods described above enable mobile terminated calls and communication attempts to be blocked to selected mobile subscribers that are roaming or receiving service in an geographic area that is designated as MT prohibited, without interfering with the subscriber's ability to place outgoing or mobile originated calls/communications. Further, the handset or phone of the called MS does not ring or other wise signal a call, and the called MS is provided no indication that a MT call attempt was blocked. This functionality is needed in communication networks, for example, to insure public safety in light of advancements in the sophistication of terrorist bombing techniques that use incoming calls, pages, or message service messages received by a mobile communication devices to trigger the detonation of explosive or otherwise destructive weapons.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A system comprising:
a database operable to mobile terminated call blocking rules; and
a mobile terminated call blocking module operable to receive data associated with a mobile terminated call attempt, determine whether the mobile terminated call attempt should be blocked by accessing the database, and block the mobile terminated call attempt in response to determining that the mobile terminated call attempt should be blocked.

2. The system of claim 1, wherein the mobile terminated call blocking module is further operable to return an error code in response to blocking the mobile terminated call attempt.

3. The system of claim 1, wherein the database is operable to store geographic location identifiers specifying areas where mobile terminated calls are prohibited.

4. The system of claim 1, wherein the database is operable to store location area code identifiers specifying areas where mobile terminated calls are prohibited.

5. The system of claim 1, wherein the database is operable to store cell identifiers specifying areas where mobile terminated calls are prohibited.

6. The system of claim 1, wherein the database is further operable to store a list of mobile subscriber identifiers whose mobile terminated calls should not be blocked.

7. The system of claim 1, wherein the database is operable to store at least one rule defining a geographic area where mobile terminated calls are prohibited.

8. The system of claim 1, wherein the database is operable to store at least one rule defining a specified date/time range during which mobile terminated calls are prohibited within a specified geographic area.

9. The system of claim 1, wherein the database is further operable to store a mapping of IMSIs to associated MSISDN identifiers and assigned roaming number identifiers.

10. The system of claim 1, wherein the database is operable to store at least one rule defining a WiFi access point that is prohibited from terminating a call.

11. The system of claim 1, further comprising a tone and announcement server operable to play an announcement to a calling party of the prohibited mobile terminated call attempt indicating that the call could not be completed.

12. The system of claim 1, wherein the mobile terminated call attempt comprises a short message service delivery attempt.

13. The system of claim 1, wherein the mobile terminated call blocking module is operable to receive a first signaling message associated with a mobile terminated call attempt, and return a second signaling message containing an error code indicative of a blocked call attempt.

14. The system of claim 1, wherein the mobile terminated call blocking module is operable to receive a first signaling message associated with a mobile terminated call attempt, and discard the first signaling message in response to blocking the call attempt.

15. A method of mobile terminated call blocking comprising:
receiving data associated with a mobile terminated call attempt to a mobile subscriber;
determining whether the mobile subscriber is located in an area where mobile terminated calls are prohibited; and
blocking the mobile terminated call attempt in response to determining that the mobile subscriber is located in an area where mobile terminated calls are prohibited.

16. The method of claim 15, wherein receiving data comprises receiving a first signaling message associated with the mobile terminated call attempt.

17. The method of claim 16, wherein blocking the mobile terminated call comprises returning a second signaling message containing an error code.

18. The method of claim 16, wherein blocking the mobile terminated call comprises discarding the first signaling message.

19. The method of claim 16, wherein receiving the first signaling message comprises receiving a signaling system 7 (SS7) message.

20. The method of claim 16, wherein receiving the first signaling message comprises receiving a session initiation protocol (SIP) message.

21. The method of claim 15, wherein determining whether the mobile subscriber is located in an area where mobile terminated calls are prohibited comprises:
determining a geographic location identifier associated with the received data; and
accessing a database having a list of prohibited geographic location identifiers.

22. The method of claim 15, wherein determining whether the mobile subscriber is located in an area where mobile terminated calls are prohibited comprises:
receiving a mobile subscriber identifier associated with the mobile terminated call attempt;
determining a geographic location identifier associated with the received mobile subscriber identifier; and
accessing a database having a list of prohibited geographic location identifiers.

23. The method of claim 15, wherein determining whether the mobile subscriber is located in an area where mobile terminated calls are prohibited comprises:
determining a geographic location identifier associated with the received data; and
accessing a database having a list of prohibited geographic location identifiers and a list of overriding permitted mobile subscriber identifiers.

24. The method of claim 15, wherein determining whether the mobile subscriber is located in an area where mobile terminated calls are prohibited comprises:
determining a geographic location identifier associated with the received data; and
accessing a database having a list of prohibited geographic location identifiers and a prohibited date/time enforcement range.

25. The method of claim 15, wherein receiving data comprises receiving a location area code identifier.

26. The method of claim 15, wherein receiving data comprises receiving a cell identifier.

27. The method of claim 15, further comprising notifying a calling party of a blocked mobile terminated call attempt that the call could not be completed.

28. The method of claim 15, wherein determining whether the mobile subscriber is located in an area where mobile terminated calls are prohibited comprises:
receiving a WiFi access point identifier;
determining the received WiFi access point identifier is prohibited from terminating a mobile terminated call.

29. The method of claim 15, wherein receiving data comprises receiving data associated with a mobile terminated short message service delivery attempt.

30. The method of claim 15, wherein receiving data comprises receiving data associated with a paging message delivery attempt.

31. A system comprising:
a first database operable to store blocked geographic area identifiers;
a second database operable to store mobile subscribers that are permitted to receive incoming calls in blocked areas identified in the first database; and
a mobile terminated call blocking module operable to receive a message associated with a mobile terminated call attempt having a mobile subscriber identifier, determine that the mobile subscriber identifier is prohibited from receiving a call by accessing the first and second databases, and blocking the mobile terminated call attempt.

32. The system of claim 31, wherein the mobile terminated call attempt comprises one of a mobile terminated voice call attempt, a mobile terminated short message delivery attempt, a voice mail notification attempt, and a paging service message delivery attempt.

33. The system of 31, further comprising a third database operable to store WiFi access point identifiers prohibited from terminating a call.
